(19) United States
(12) Patent Application Publication
(10) Pub. No.: US 2015/0377218 A1
(43) Pub. Date: Dec. 31, 2015

(54) ROTATING UNIT FOR ROTATING A COMPONENT MOUNTED IN A ROTATBLE MANNER ON A WIND TURBINE

(71) Applicant: SENVION SE, Hamburg (DE)

(72) Inventors: Alf Trede, Immenstedt (DE); Carsten Eusterbarkey, Simonsberg (DE)

(21) Appl. No.: 14/737,484

(22) Filed: Jun. 11, 2015

(30) Foreign Application Priority Data
Jun. 26, 2014 (DE) 102014009306.9

(51) Int. Cl. F03D 11/02; F03D 11/00; F03D 1/00; F03D 1/06

(52) U.S. Cl. CPC F03D 11/02; F03D 1/06; F03D 11/0075; F03D 1/001

(57) ABSTRACT

A rotating unit for rotating a first component of a wind turbine rotatably mounted on a second component, which includes a gearwheel element arranged on the first component, a drive arranged on the second component by a drive holder including a drive housing and a drive pinion for actuating the gearwheel element, a connecting element arranged on the drive housing and configured to form a releasable connection between the drive housing and the drive holder, and fastening means, which interact with the connecting element and can be actuated between a clamping position and a disengagement position. The fastening means connect the drive housing, in the clamping position, in a force-fitting manner to the drive holder. In the disengagement position, the drive housing is displaceable on the drive holder in an adjustment direction such that it is possible to adjust a tooth-flank clearance between the drive pinion and the gearwheel element.

### FIELD OF INVENTION

The invention relates to a rotating unit for rotating a first component of a wind turbine in relation to a second component of the wind turbine, and to a method of displacing a drive of a rotating unit according to the invention and to a wind turbine having a rotating unit according to the invention.

### BRIEF DESCRIPTION OF RELATED ART

Rotating units of the type mentioned in the introduction are used on wind turbines in order to rotate, for example, a rotor blade, which is mounted in a rotatable manner on a rotor hub, in relation to the rotor hub. Such rotating units also serve to rotate the nacelle, or a machinery carrier with a nacelle, in relation to the turbine tower. The rotation of a rotor blade is known as pitch adjustment and the rotation of the turbine nacelle in relation to the tower is known as azimuth adjustment.

Wind turbines are used preferably in areas which are particularly exposed to wind, for example offshore. The rotor blades and the turbine nacelle here are usually exposed to strong winds and have to withstand strong gusts of wind. The forces which are necessary in order to rotate the rotor blades or the turbine nacelles increase along with the wind speeds.

The wind turbines often make use of rotating-unit drives which, on the one hand, generate high torques and, at the same time, are not adversely affected by force-induced impacts brought about by gusts of wind and high wind speeds. Such impacts act, via the rotating unit, on the components of the drive and result in high material loading. In order to keep the loading to which the drive components are subjected as low as possible, it is imperative for a toothing formation of a drive pinion to engage in an accurately fitting manner in a toothing formation of a gear rim of the rotating unit.

In order for the tooth-flank clearance to be adjusted, the drive pinion can usually be displaced in relation to the gear rim. The adjustment of the tooth-flank clearance is necessary, on the one hand, in order to compensate for inaccuracies in the production of the components of the wind turbine and, on the other hand, in order to compensate for wear which becomes established during use of the wind turbine. The loading, and so also the wear, to which the tooth flanks are subjected increases along with the torque emitted by the drive motor in order to rotate the components in relation to one another. It is also the case that gusts of wind which act on the rotating unit result in the drive components being subjected to increased loading and also in wear between the rotary wheels of the rotating unit. The less precise the tooth-flank clearance is set, the higher the degree of wear. Regular readjustment is therefore advised.

The prior art discloses two possible ways of adjusting the tooth-flank clearance between the drive pinion and the gear rim. In the case of both known variants, the housing of the rotary drive is plugged in an accurately fitting manner into a recess of a holder, that is to say into an accommodating hole or into an accommodating bore, and fixed. Forces which act on the drive pinion are transferred to the holder via the housing of the drive and dissipated to the wind-turbine component which carries the drive.

In order for the tooth-flank clearance to be adjusted, it is known, first of all, for the drive shaft of the rotary drive with the drive pinion to be executed eccentrically in relation to the housing of the drive. In order for the pinion of the rotary drive to be displaced in relation to the gear rim, the drive housing is rotated in the accurately fitting recess of the drive holder. The drive shaft with the drive pinion, the former moving on a circular track here, is thus guided relatively closely up to the gear rim. For rotation of the drive, firstly all the fastening bolts connecting the housing of the rotary drive to the drive holder have to be released, removed completely from the flange bores provided for this purpose and, following rotation of the drive, fastened again. The drive holder is also referred to as a drive bracket or drive platform. This first variant is portrayed in FIGS. 3 and 4 of the present application.

A second known variant for adjusting the tooth-flank clearance will be explained with reference to FIGS. 5 and 6 of the present application. In the second variant, the rotary drive is plugged in an accurately fitting manner into an eccentric mount of a cylindrical eccentric cup. The eccentric cup, finally, is inserted in an accurately fitting manner into a recess of the drive holder. The eccentric cup is typically fastened on the drive holder via a collar-like flange using fastening bolts. The drive is also fastened on the eccentric cup in the same way.

In order for the tooth-flank clearance to be adjusted, in this second variant, the fastening bolts connecting the eccentric cup to the drive holder are all released and removed, and the eccentric cup is rotated in the recess of the drive holder and then fastened on the drive holder again using the fastening bolts. In this variant, the drive is not released from the eccentric cup. The drive is arranged eccentrically in the eccentric cup and, upon rotation of the eccentric cup, describes, together with the drive pinion, a circular-track-form movement, and therefore the distance between the pinion and the gear rim can be adjusted via the rotation of the eccentric cup.

Both known variants provide for stepwise adjustment of the distance between the drive pinion and the gear rim. The steps are determined by the distribution of the bores provided for the fastening bolts along the fastening collar of the drive or of the eccentric cup.

The disadvantage with the known rotating units is that it is necessary to rotate the drive alone or the drive with an eccentric cup. The necessary rotation means that the supply lines connected to the rotary drive, for example lines for hydraulic fluids, electrical energy, cooling fluids and signal-transmission lines, have to be arranged in a particularly flexible manner on the drive or in the wind turbine. As an alternative, it is necessary for the supply lines to be separated from the drive in the first instance and to be repositioned following rotation of the drive. Upon rotation of the drive as a whole, it is also not ensured that oil drains, terminal boxes and, in particular, angle drives are oriented correctly following the rotation.

A further disadvantage of the known apparatuses is that the rotation of the drive housing or of the eccentric cup in the drive holder requires a high level of force to be applied on account of the accurately fitting seating in the recess. As a result, a large diameter of the drive housing or of the eccentric cup means large frictional surfaces and high frictional forces have to be overcome during rotation. In addition, it is only with difficulty that those areas where there are tight fits against the accommodating recesses can be protected against corrosion. The task of removing and rotating the drive or the eccentric cup is very time-consuming and labor-intensive if recesses are corroded.

Taking this as a departure point, it is an object of the present invention to provide an improved rotating unit, and also a method and a wind turbine, in which a tooth-flank clearance can be adjusted straightforwardly, and with low levels of force being applied, while, at the same time, the drive housing is subject to only small amounts of rotation.

This object is achieved by the rotating unit according to the invention, by the method according to the invention and by the wind turbine according to the invention. Preferred configurations of the invention are also disclosed and claimed.

### BRIEF SUMMARY OF THE INVENTION

The invention provides a rotating unit for rotating a first component of a wind turbine in relation to a second component of the wind turbine, the first component being mounted in a rotatable manner on the second component, comprising a gearwheel element, which is arranged on the first component, a drive, which is arranged on the second component by means of a drive holder and has a drive housing and a drive pinion for actuating the gearwheel element, a connecting element, which is arranged on the drive housing and is configured for forming a releasable connection between the drive housing and the drive holder, fastening means, which interact with the connecting element and can be actuated between a clamping position and a disengagement position, the fastening means connecting the drive housing, in the clamping position, in a force-fitting manner to the drive holder, and it being possible for the drive housing, in the disengagement position, to be displaced on the drive holder in particular in a stepless manner in an adjustment direction such that, by virtue of the displacement, it is possible to adjust a tooth-flank clearance between the drive pinion and the gearwheel element, wherein the drive housing, in the disengagement position, can be displaced by virtue of the rotation of at least one eccentric bolt, which is or can be coupled to the connecting element, in relation to the gearwheel element. It goes without saying that the components can be mounted rotatably in relation to one another while directly against one another or while spaced apart by spacers.

The drive is fastened on a component of a wind turbine in particular via a drive holder or a drive bracket or a drive platform. In a straightforward configuration, the drive holder is L-shaped, a first limb being fastened on the component of the wind turbine and the second limb carrying the drive. The drive holder may be fastened in a fixed or releasable manner on the wind-turbine component which carries the drive. In particular, the drive holder may be formed in one piece with the component of the wind turbine.

It has surprisingly been found in the case of the present invention that, for the purpose of fastening the rotating-unit drive on a component of the wind turbine, it is possible to dispense with accurately fitting seating of the drive housing in a recess of a drive holder. All that is required, instead, in order for the drive to be retained reliably is for the drive to be fastened in a force-fitting manner on the drive holder by means of a fastening flange. This has the advantage firstly that there is no need to provide any precise recesses or cutouts in the drive holder and also that positioning of the drive in relation to a gear rim, for example for adjusting the tooth-flank clearance, can be carried out very straightforwardly.

In the case of the invention, provision may be made for the drive housing with the drive to be fastened entirely on one side of a for example plate-like limb of a drive holder. It is also conceivable to use a recess, in which the drive housing can be moved freely at least in certain regions. As seen in the plane of the drive holder in the region of the accommodating recess for the drive, the largest diameter of the drive housing, for this purpose, is preferably smaller than the smallest diameter of the recess opening. In both variants, the drive can be displaced quickly, and with little force being applied, on the drive holder with the aid of displacement mechanisms which can be produced in a constructionally straightforward manner. This, in turn, has the advantage that a tooth-flank clearance between a drive pinion of the drive and a gearwheel element of the rotating unit according to the invention can be adjusted straightforwardly and quickly.

Tooth-flank clearance is understood to be, in particular, the clearance which occurs between the toothing formation of the drive pinion and the toothing formation of the gearwheel element and has to be overcome upon reversal of the direction of rotation. A reduction in the tooth-flank clearance is achieved by an increase in the depth to which a toothing formation of the drive pinion engages in the toothing formation of the gearwheel element.

Since the invention does not require any recess for guiding the drive, parts of the drive can advantageously be provided with a coating and protected to good effect against corrosion.

The absence of an accurately fitting recess does away with the otherwise necessary precise adaptation of the recess opening to the dimensions of the drive housing. In addition, doing away with an accurately fitting recess means that it is readily possible to use a drive housing of irregular housing shape or of angular circumferential shape.

In contrast to the prior art as described in the introduction, there is no need for the fastening means, which are designed preferably in the form of fastening screws, to be removed completely from the drive housing in order for the drive to be displaced on the drive holder. Rather, it is sufficient for the fastening bolts, or nuts screwed onto the bolts, to be released only to the extent where the prestressing in the fastening means, which is necessary for the force-fitting connection between the drive housing and the drive holder, is eliminated.

Stepless displacement without removal of the fastening bolts is made possible, for example, in that the stem of the bolts is configured to be narrower than the diameter of the through-bores provided for the bolts in the connecting element of the drive housing. It is preferable for the fastening bolts, in order to fasten the drive housing, to be screwed into threaded bores of the drive holder. In accordance with this configuration, it is also conceivable for the fastening bolts to be plugged through through-bores on the drive holder and screwed into threaded bores of the connecting element of the drive housing.

As an alternative, provision may be made for mutually aligned through-bores to be provided on the connecting element of the drive housing and on the drive holder, fastening bolts being plugged through said bores, and screw-connected to nuts at their ends, in order to fasten the drive on the drive holder. In the last-mentioned embodiment, provision may also be made for at least some through-bores either on the connecting element of the drive housing or on the drive holder to be made in an accurately fitting manner in relation to the bolt stem. The aforementioned screw-connection methods and in particular the practice of establishing a force-fitting connection are common knowledge.

The connecting element according to the invention on the drive housing may be, for example, a collar-like flange profile which runs round the circumference of the drive housing. Connecting elements of other profiles are, of course, also conceivable. For example, the connecting element could be formed from one or more angled profiles, a first limb of the profile being fastened on the drive housing and the other limb of the profile being fastened on the drive holder.

The gearwheel element is understood to be both a closed gear rim and a segment of a gear rim. Upon rotation of two components of a wind turbine, it may be the case, for example, that the intention is for rotation to be carried out only over a certain angle, in which case it is only this angle range which has to be covered by a gear-rim segment. This makes it possible to cut back on weight and materials. Gear-rim segments have the further advantage that they are considerably more straightforward to handle, to install and to change over.

Straightforward and quick displacement of the drive on the drive holder is achieved by using an eccentric bolt according to the invention. For this purpose, the eccentric bolt is coupled to the drive holder and the connecting element of the drive housing such that rotation of the eccentric bolt gives rise to displacement of the drive element in relation to the drive holder. The stem of the eccentric bolt is mounted in a preferably accurately fitting manner in a bore of the connecting element. A rotary bearing, which is arranged on the eccentric bolt in an eccentric and axis-parallel manner in relation to the stem axis, serves to provide support on the drive holder. The eccentric bolt is preferably plugged into a bore provided for a fastening bolt. The rotary bearing on the eccentric bolt may be, for example, a pin which has been pressed in or screwed in or a stub which has been formed eccentrically.

The eccentric bolt can be fixed to the connecting element and/or the drive holder. As an alternative, the eccentric bolt can be connected, in the manner of a tool, in a releasable manner to the connecting element and/or the drive holder. If configured in the form of a tool, the eccentric bolt is inserted, if required, for example into a bore provided specifically for this purpose or is changed over at least temporarily for a fastening bolt.

A significant advantage of the invention is that the eccentric bolt has a very small diameter in relation to the drive housing and thus generates only a low level of friction and is easy to rotate. Moreover, the orientation of oil drains, terminal boxes and angle drives is simplified by more or less rectilinear displacement of the drive, and there is therefore no need, for example, for renewed orientation following the adjustment of the tooth-flank clearance.

In a preferred configuration, the first component is a rotor hub and the second component is a rotor blade. As an alternative, the first component is a tower and the second component is a machinery carrier with a nacelle. It is also conceivable for the second component to be a rotor hub and the first component to be a rotor blade, or for the second component to be a tower and the first component to be a machinery carrier with a nacelle. The nacelle is a structural component of the wind turbine and serves, inter alia, to accommodate the transmission and the generator of the wind turbine. The nacelle is also referred to as a machinery housing and is usually installed on a machinery carrier, which also retains the transmission and the generator of the wind turbine.

Different variants of the rotating unit according to the invention may be arranged on the wind turbine. As mentioned, the gearwheel element may be designed in the form of a closed gear rim or in the form of a gearwheel segment. The gearwheel element preferably has an inner toothing formation in the manner of a hollow wheel, the drive pinion being positioned in relation to the gearwheel element such that the toothing formation of the drive pinion engages in the toothing formation of the gear rim. It is also conceivable, of course, for the gearwheel element to be configured with an outer toothing formation.

It is usually the case that the gearwheel element is arranged directly, or via a holder, on a first component and the drive is arranged directly, or via a holder, on a second component of the wind turbine. If the wind-turbine components which are to be rotated are spaced apart from one another by a spacer sleeve or the like, provision may also be made for the gearwheel element or the drive to be fastened on the spacer sleeve. In the case of some wind turbines, for example the rotor blade is mounted on the rotor hub by means of a spacer sleeve.

It is possible, for example, for the gearwheel element to be arranged on a tower of the wind turbine and for the drive to be fastened on a region of the nacelle, or of the machinery carrier carrying the nacelle, which is mounted in a rotatable manner on the tower. The drive here rotates as the drive pinion rotates in relation to the gearwheel element. Conversely, the gearwheel element rotates in a relation to the drive. Corresponding provisions can be made for the arrangement between the rotor hub and rotor blade.

The drive housing can further preferably be displaced in a number of adjustment directions spanning an adjustment plane, at least some of the fastening means, in the disengagement position, limiting displacement of the drive housing in a direction perpendicular to the adjustment plane. Limitation of the displacement of the drive housing in a direction perpendicular to the adjustment plane is advantageous, in particular, if the drive is installed in a suspended manner. When the tooth-flank clearance is adjusted, it is not additionally necessary for the drive to be secured against falling. The safeguarding can at least be assisted by the fastening means.

In a further configuration of the invention, the eccentric bolt can be articulated in a rotatable manner on the second component. In particular, it is intended to provide, at one end of the eccentric bolt, an eccentrically arranged stub, which is supported in a rotatable manner in a bore on the second component or on the drive holder. As an alternative, it is possible to provide a pin which can be coupled in a rotatable manner to the eccentric bolt. The pin may be, for example, a bolt or the like which is supported in a bore on the second component or on the drive holder. The pin can be press-connected or screw-connected, in particular, to the second component or the drive holder or formed thereon. In order for the eccentric bolt to be used, the latter is plugged onto the pin.

In one configuration, the eccentric bolt has an actuating element, by means of which the eccentric bolt can be rotated about its axis of rotation in particular utilizing a lever effect. In a straightforward variant, it is possible, for example, for a lever to be connected in one piece to the eccentric bolt, and therefore, upon actuation of the lever, the eccentric bolt is made to rotate and thus ensures displacement of the drive housing. It is also intended as an alternative, or in addition, that the eccentric bolt has a head or the like, by means of which the eccentric bolt can be rotated using a tool. Instead of a head, a profiled depression, for example a hexagon-socket bore, on the eccentric bolt is also readily conceivable.

In a preferred configuration, the drive housing, during displacement on the drive holder, is guided positively by at least one guide element. It is intended, for example, that a guide element in the form of a guide bolt or of a guide nipple is fastened on the drive holder and engages in a guide track on the connecting element. The guide track is designed preferably in the form of a slot or longitudinal groove. The guide element is formed preferably in one piece on the drive holder. The guide element may be welded to the holder or screwed or pressed into the same. It is readily conceivable for the guide element to be arranged on the connecting element and for the guide track to be arranged on the drive holder in the manner described. The eccentric bolt is preferably a guide element. In particular, it is intended that the drive housing is guided positively by the eccentric bolt and by at least one further guide element.

In a preferred configuration, the axis of rotation of the eccentric bolt and at least one guide element are positioned along a straight line which intersects the axis of rotation of the gearwheel element. This arrangement has the advantage that a rotary movement of the eccentric bolt is converted very efficiently into displacement of the drive pinion. It is preferably the case, therefore, that the axis of rotation of the eccentric bolt and a guide element are arranged in alignment with the axis of rotation of the gearwheel element.

The drive housing is preferably guided such that a rotary movement of the eccentric bolt is converted, at least in certain regions, into an approximately rectilinear movement of the drive housing. It is particularly preferably the case, for this purpose, that the eccentric bolt and at least one guide element are positioned along a straight line which intersects the axis of rotation of the gearwheel element, the drive housing of the drive likewise being positioned on this straight line. Further preferably, the drive housing is positioned between the eccentric bolt and the guide element. It has been found that, in the case of a particularly practical variant, the guide element is arranged on that side of the drive which is directed towards the gearwheel element and the eccentric bolt is arranged on that side of the drive which is directed away from the gearwheel.

The invention also provides a method of displacing a drive of a rotating unit according to the invention, having the following steps: actuating the fastening means into the disengagement position in order to release the force-fitting connection between the drive housing and the drive holder, rotating the eccentric bolt in order to displace the drive housing on the drive holder, actuating the fastening means into the clamping position in order to establish a force-fitting connection between the drive housing and the drive holder. It is intended to implement the method using a rotating unit having the physical features as disclosed herein. The details relating to the advantageous configurations of the rotating unit yield preferred variants of the method according to the invention.

In one configuration of the method according to the invention, it is intended that the method comprises a selection of the following steps: coupling the eccentric bolt to the connecting element such that rotation of the eccentric bolt gives rise to displacement of the drive housing in relation to the gearwheel element; uncoupling the eccentric bolt from the connecting element. Provision is preferably made for the eccentric bolt to be coupled prior to fastening means being actuated into the disengagement position. It is likewise preferred for the eccentric bolt to be uncoupled once the fastening means have been actuated into the clamping position.

In the case of a rotating unit having an eccentric bolt which is coupled permanently to the connecting element, the step of coupling the eccentric bolt to the connecting element such that rotation of the eccentric bolt gives rise to displacement of the drive housing in relation to the gearwheel element and the step of uncoupling the eccentric bolt are done away with. In the case of permanent coupling, provision is made for the eccentric bolt to be arranged in sustained fashion on the connecting element. Provision may also be made for the eccentric bolt to be arranged permanently on the drive holder. The coupling of the eccentric bolt is established here when the drive with the connecting element is arranged in its operating position on the drive holder. The connecting means can be actuated, and/or the eccentric bolt can be rotated, using a tool, in particular using a wrench, a motor-driven screwdriver or the like.

The invention may also provide a rotating unit in which the drive housing can be displaced by virtue of at least one adjustment element being actuated in relation to the gearwheel element, the drive housing, during the displacement, executing an exclusively translatory movement in relation to the gearwheel element. With the exception of the use of an eccentric bolt, the technical details relating to the first-mentioned rotating unit can be applied correspondingly to this rotating unit.

The advantage of this rotating unit is that the entire drive can be displaced rectilinearly in relation to the gearwheel element. The exclusively rectilinear displacement has the advantage that connection lines and/or supply lines for the drive need not be particularly flexible. In contrast to what is usually the case in the prior art, there is no rotation whatever of the drive housing, and this renders constructionally simplified guidance of supply and/or control lines possible.

Provision may be made for the adjustment element to comprise a threaded bar with an external thread, the external thread, for displacement of the drive housing, engaging in an internal thread arranged at a fixed location of the second component.

The invention also provides a wind turbine having a rotating unit according to the invention. The advantages of the wind turbine according to the invention can be gathered from the merits of the rotating unit.

### BRIEF DESCRIPTION OF THE DRAWINGS

Exemplary embodiments of the invention are specified in the following figures, in which:

FIG. 1 shows a schematic depiction of a wind turbine from the side;

FIG. 2 shows a basic diagram of a gearwheel and of a drive pinion;

FIG. 3 shows a schematic depiction of a plan view of a known rotating-unit drive on a drive holder;

FIG. 4 shows a sectional illustration of the known drive from FIG. 3;

FIG. 5 shows a schematic depiction of a plan view of a known rotating-unit drive on a drive holder;

FIG. 6 shows a sectional illustration of the drive from FIG. 5;

FIG. 7 shows a schematic illustration of a plan view of a rotating-unit drive according to the invention on a drive holder;

FIG. 8 shows a sectional illustration of the drive according to the invention from FIG. 7;

FIG. 9 shows a sectional illustration of an eccentric bolt according to the invention inserted into a fastening flange;

FIG. 10 shows the arrangement of the eccentric bolt according to the invention from FIG. 9 in plan view;

FIG. 11 shows a schematic illustration of a fastening flange of a rotary drive in an embodiment according to the invention; and

FIG. 12 shows a schematic illustration of a further variant of a rotary drive on a drive holder.

### DETAILED DESCRIPTION OF THE INVENTION

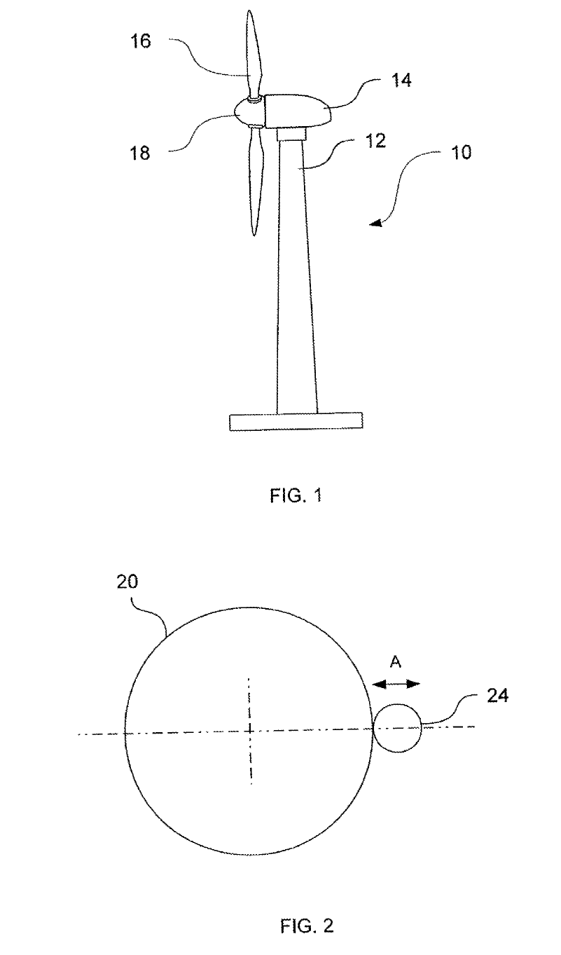

FIG. 1 shows a schematic view of a wind turbine. A rotating unit according to the invention is used, for example, for rotating a rotor blade 16 in relation to a rotor hub 18. During this relative movement, it is possible to alter the pitch adjustment of the rotor blade 16. A rotating unit according to the invention can likewise be used for the rotation of a turbine nacelle 14 in relation to the turbine tower 12. The azimuth adjustment of the wind turbine 10 is altered as the nacelle 14 rotates.

FIG. 2 shows a basic diagram of a gear rim 20 and a drive pinion 24 interacting with the gear rim 20. In order for a tooth-flank clearance between the gear rim 20 and the pinion 24 to be adjusted, the pinion 24 is displaced, in relation to the gear rim, in one of the directions identified by A.

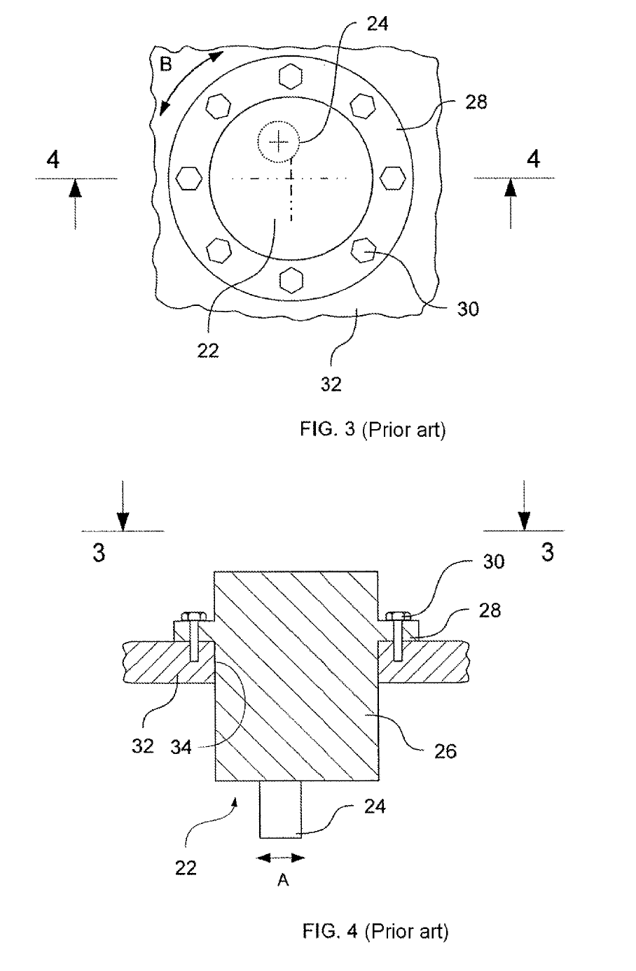

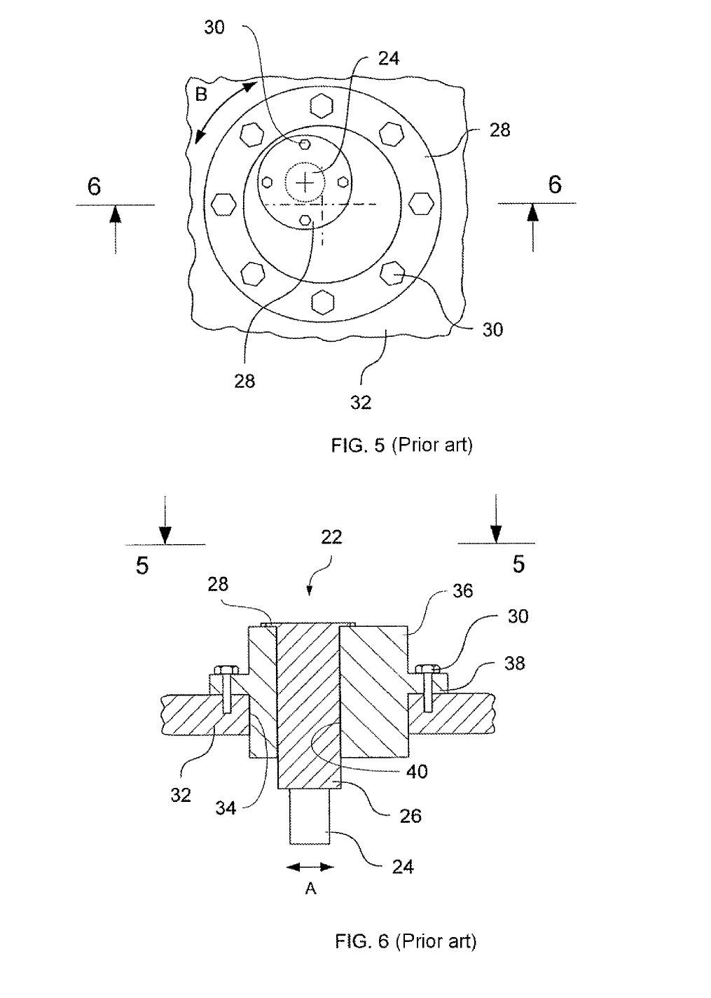

FIGS. 3 and 4 show the basic construction of a known rotating-unit drive 22. FIG. 3 is a plan view of a rotating-unit drive 22 as seen in the axial direction of the latter. Taken from the perspective of FIG. 3, the drive pinion 24, which is illustrated by dashed lines, is concealed by the housing of the drive 22. The rotating-unit drive 22 is inserted in an accurately fitting manner in a recess 34 of a drive holder 32. As is also the case in FIGS. 5-8, the drive 22 is plugged into the recess 34, 40 usually with the drive pinion 24 in front. The drive pinion 24 and fastening flange are thus positioned on different sides of the drive holder 32. The housing 26 of the drive 22 is fastened on the drive holder 32 by means of a fastening flange 28. Threaded bolts 30 serve for fastening purposes. As can be seen in FIGS. 3 and 4, the drive pinion 24 is arranged on the drive 22 eccentrically in relation to the drive housing 26. In order to clarify matters, the eccentricities are illustrated in a highly exaggerated state in this illustration and the following ones.

In order for the tooth-flank clearance between the gear rim 20, which is illustrated in FIG. 2, and the drive pinion 24 to be adjusted, first of all the fastening bolts 30 are released and removed from the fastening flange 28, this making it possible to rotate the drive housing 26 in the recess 34 of the drive holder 32. Upon rotation of the drive 22 in one of the directions B, the distance between the drive pinion 24 and the gear rim 20 alters (cf. FIG. 2). The relative movement of the drive pinion 24 is indicated at A in FIG. 4. Displacement in one of the directions A is achieved in that the drive pinion 24, upon rotation of the drive 22 in one of the directions B, is moved on a circular track about the longitudinal axis of the drive 22. The distance of the drive pinion 24 in relation to the gear rim 20 decreases or increases as the drive pinion passes over this circular track (cf. FIG. 2).

As can be seen, in particular, in FIG. 4, in the case of this known variant, the drive housing 26 is inserted in an accurately fitting manner into the recess 34 of the drive holder 32. The forces which arise upon interaction of the drive pinion 24 and gear rim 20, and are absorbed by the drive pinion 24, are absorbed, and compensated for by the accurately fitting seating of the drive housing 26 in the recess 34 through the drive holder 32.

FIGS. 5 and 6 show a second variant of a known arrangement for a rotating-unit drive 22 in a drive holder 32. FIG. 5 is a plan view of the rotating-unit drive 22 as seen in the axial direction of the latter. Taken from the perspective of FIG. 5, the drive pinion 24, which is illustrated by dashed lines, is concealed by the housing of the drive 22. In contrast to the variant from FIGS. 3 and 4, the drive 22, rather than being retained directly in a recess 34 of the drive holder 32, is located in an accurately fitting manner in a recess 40 of an eccentric cup 36. The eccentric cup 36, for its part, is inserted in an accurately fitting manner in the recess 34 of the drive holder 32. First fastening bolts 30 are used to fasten the drive 22, by way of a fastening flange 28 of the drive housing 26, in the recess 40 of the eccentric cup 36. The eccentric cup 36, for its part, has a fastening flange 38, by means of which the eccentric cup 36 is fastened on the drive holder 32 by way of two fastening bolts 30. The recess 40 is arranged eccentrically in the eccentric cup 36. This variant has the advantage, over the variant from FIGS. 3 and 4, that use can be made of a drive which has a centrally arranged drive shaft and/or a centrally arranged drive pinion 24. Drives with the drive shaft arranged centrally are easier to produce and more cost-effective. In order to achieve displacement of the drive pinion 24, the fastening bolts 30, which fasten the eccentric cup 36 on the drive holder 32, are released and removed from the fastening flange 38. The eccentric cup 36 can then be rotated in one of the directions B in the recess 34 of the drive holder 32. Upon movement of the eccentric cup 36 in one of the directions B, the drive pinion 24 of the drive 22 describes a circular track about the centerpoint of the eccentric cup 36. Upon rotation of the eccentric cup 36, the drive pinion 24 is displaced in one of the directions A in relation to the gear rim 20 (cf. FIG. 2). With the necessary amounts of eccentricity in reality being very small, instead of the first and second fastening bolts 30, it is often the case that just one set of fastening bolts is provided for the screw-connection of the drive 22, eccentric cup 36 and drive holder 32 in one connection.

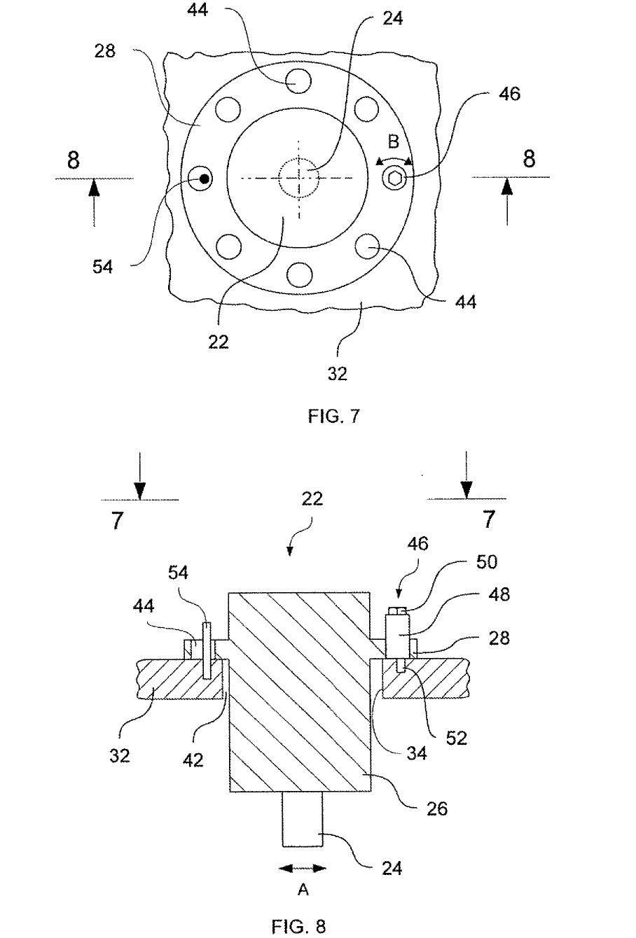

FIGS. 7 and 8 show a schematic illustration of a plan view of a rotating-unit drive 22 according to the invention and a sectional illustration of the same. FIG. 7 is a plan view of the rotating-unit drive 22 as seen in the axial direction of the latter. Taken from the perspective of FIG. 7, the drive pinion 24, which is illustrated by dashed lines, is concealed by the housing of the drive 22. According to the invention, an eccentric bolt 46 is arranged on the drive 22. The eccentric bolt 46 is plugged into one of the bores 44 arranged on the fastening flange 28. Indicated as being located opposite the eccentric bolt 46 on the fastening flange 28 is a guide element 54, which is designed in the form of a round bar and serves, inter alia, for guiding the drive housing 26 during displacement along the drive holder 32. The guide element 54 is preferably screwed or plugged into the drive holder 32. When the drive 22 is seated on the drive holder 32, the guide element 54 projects through a bore 44 and thus limits the movement path of the drive 22. It is preferably also possible for the bore 44 in the region of the guide element 54 to be configured in the form of a slot (not illustrated).

The guide elements 54 are preferably designed in the form of threaded bolts. Guide elements 54 designed in the form of threaded bolts can perform a double function. On the one hand, they can be used for guiding the drive 22 and, on the other hand, they can establish a force-fitting connection between the fastening flange 28 or the drive housing 26 and the drive holder 32. The guide elements 54 can correspond to the fastening bolts 30 shown in FIGS. 3 to 6.

As can be seen in FIGS. 7 and 8, the diameter of the guide element 54 is smaller than the diameter of the bores 44. This allows displacement of the drive 22 along a surface of, or relatively to, the drive holder 32 without the elements 54 being removed from the drive holder 32 or from the fastening flange 28.

The displacement of the drive 22, and thus of the drive pinion 24, is achieved by the rotation of the eccentric bolt 46 in one of the directions B. Upon rotation of the eccentric bolt 46, the drive housing 26 is displaced, with positive guidance, on the drive holder 32. In the exemplary embodiment illustrated, the drive housing 26 is plugged into a recess 34 of the drive holder 32. A gap 42 is located between the opening periphery of the recess 34 and the drive housing 26. The gap 42 and the clearance of the guide element 54 in the bore 44 allows displacement of the drive housing 26 as a whole in the recess of the drive holder 32.

In order for the eccentric bolt 46 to be actuated, a head 50 is arranged at its end which retains the drive 22. The head 50 can be actuated, for example, using a wrench or the like and utilizing a lever effect.

As portrayed in FIG. 8, the eccentricity 48 of the eccentric bolt 46 is seated in an accurately fitting manner in a bore of the fastening flange 28. This bore may be, for example, a through-bore 44 provided for fastening means.

Upon rotation of the eccentric bolt 46, the eccentricity 48 is rotated about an eccentric pin 52. The pin may be a bar which has been screwed or plugged/pressed into the drive holder 32. The eccentric pin 52 may preferably also be a shaft which is configured in a rotationally fixed manner with the eccentric bolt 46 and is guided in a bore in the drive holder 32.

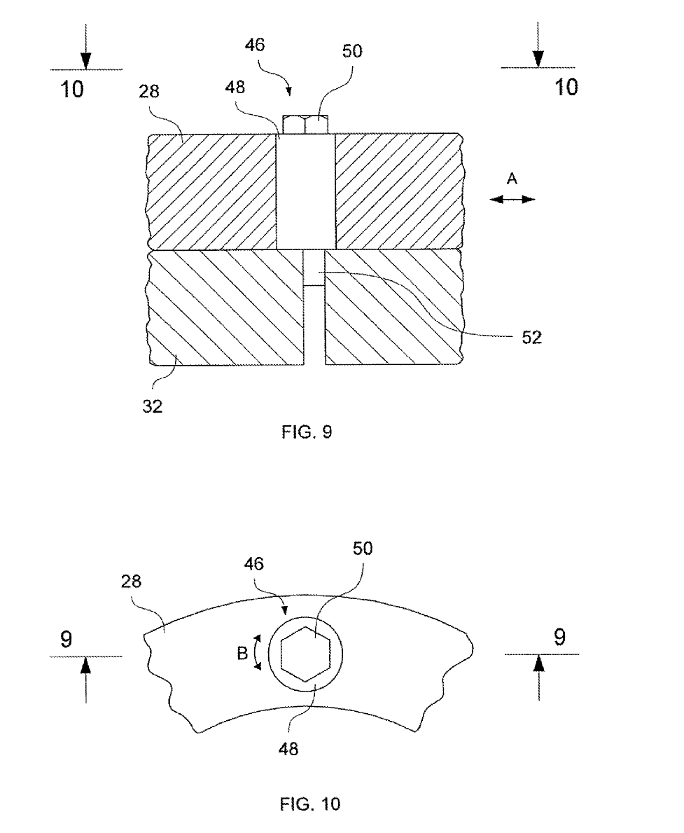

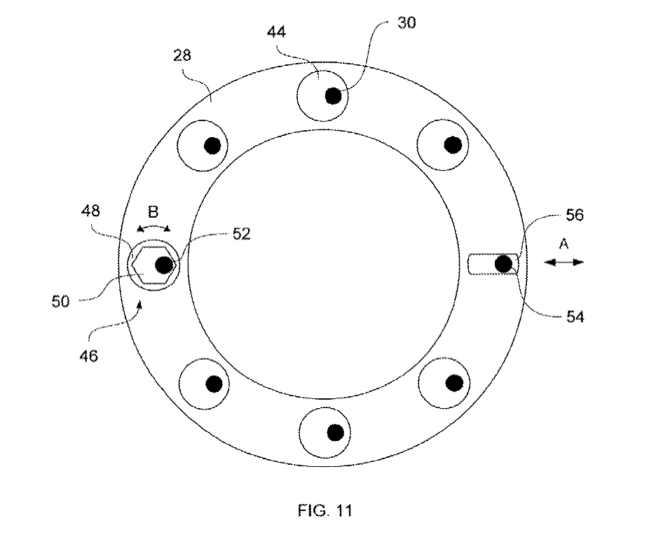

FIGS. 9 and 10 show a sectional illustration and a plan view, both in detail form, of the eccentric bolt 46 according to the invention. FIG. 9 shows, in particular, accurately fitting seating of the eccentric bolt 46 in the fastening flange 28 and the engagement of the eccentric pin 52 in a through-bore of the drive holder 32. Upon rotation of the eccentric bolt 46, the fastening flange 28 moves in one of the directions A in relation to the drive holder 32.

FIG. 11 shows a schematic illustration of a preferred variant of the fastening flange 28. In contrast to FIG. 7, a slot 56 is formed in the fastening flange 28. The slot 56 is located opposite to the eccentric bolt 46. A guide element 54, which is fastened on the drive holder 32 (not illustrated), is plugged into the slot 56. Upon displacement of the drive 22 and the drive holder 32, the drive 22 is guided positively in the slot 56 by the guide element 54. This means that rotary movement of the eccentric bolt 46 on a first side of the fastening flange 28 can be converted into an approximately rectilinear movement of the drive housing 26 on the opposite side of the fastening flange 28. It is also conceivable for the slot 56 to be arranged on the drive holder 32, and for a guide element 54 arranged on the fastening flange 28 to engage in the slot 56 (not illustrated). As mentioned in relation to FIG. 7, the guide element 54 may be designed in a form of a fastening bolt.

Fastening bolts 30 are shown in the bores 44 in FIG. 11. The fastening bolts 30 are depicted without a head or nut, so that the clearance of the bolts within the bores 44 is evident.

The eccentric pin 52, about which the eccentric bolt 46 can be rotated, is illustrated purely schematically on the head 50 of the eccentric bolt 46. Preferably, and irrespective of the present exemplary embodiment, the rotary pin 52 of the eccentric bolt 46 and a guide element 54 are arranged on the fastening flange 28 in alignment with the axis of rotation of the gearwheel element 20 (not illustrated). Further preferably, the eccentric bolt 46 is arranged on that side of the drive 22 which is directed away from the gearwheel element 20. Correspondingly, it is possible for the eccentric bolt 46 with its rotary pin 52 and a guide element 54—arranged on the drive holder 32, opposite the eccentric bolt 46, and/or on the drive housing 26 or on the fastening flange 28—to be positioned on a line which intersects the axis of rotation of the gearwheel element 20. This results in particularly efficient conversion of the rotary movement of the eccentric bolt 46 into a displacement movement of the drive 22 in the direction of the gearwheel element 20. The drive housing 26 is preferably arranged in a line between the eccentric bolt 46 and the guide element 54.

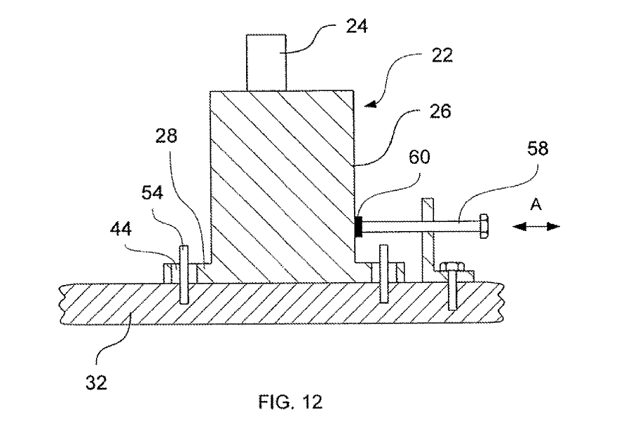

FIG. 12 shows another exemplary embodiment of a rotary drive according to the invention. Instead of the eccentric bolt 46, use is made here of an adjustment element 58 for displacing the drive 22 and the drive holder 32. Design elements such as the bores 44, the guide elements 54, the flange 28, the drive pinion 24 or the drive holder 32 are identical to, or along the same lines as, the embodiments of the preceding figures. In contrast to FIGS. 3-8, the drive housing 26 is not plugged into a recess of the drive holder 32. Here, the drive 22, with the drive housing 26, is arranged entirely on one side of the drive holder 32. This arrangement is readily also conceivable for the exemplary embodiment of FIGS. 7 and 8.

According to this exemplary embodiment, the adjustment element 58 serves for displacing the drive 22. For this purpose, the adjustment element 58 has an elongate region with an external thread, which engages in an internal thread (not illustrated) arranged at a fixed location in relation to the drive holder 32. The adjustment element 58 may be, for example, a threaded bolt.

At the end which is directed away from the drive 22, the adjustment element 58 has a head or the like, which can be actuated using a tool, e.g. a wrench, for rotating the adjustment element 58. That end of the adjustment element 58 which is located opposite the head has arranged on it a coupling element 60, by means of which the adjustment element 58 is connected to the drive housing 26. The coupling element 60 can transmit a compressive or tensile force from the adjustment element 58 to the drive housing 26. The coupling element 60 is preferably fixed to the drive housing 26.

As an alternative, or in addition, it is possible—as described in relation to FIGS. 7 to 11—to introduce into one of the bores 44 an eccentric bolt 46 which serves for displacing the drive 22 or assists the displacement. An adjustment element 58 can be used to assist displacement or to assist the task of fixing the drive 22 on the drive holder 32.

List of designations:

| | |
|---|---|
| 10 | Wind turbine |
| 12 | Tower |
| 14 | Turbine nacelle |
| 16 | Rotor blade |
| 18 | Rotor hub |
| 20 | Gear rim |
| 22 | Rotating-unit drive |
| 24 | Drive pinion |
| 26 | Drive housing |
| 28 | Fastening flange of the drive |
| 30 | Fastening bolt |
| 32 | Drive holder |
| 34 | Recess in the drive holder |
| 36 | Eccentric cup |
| 38 | Fastening flange of the eccentric cup |
| 40 | Recess in the eccentric cup |
| 42 | Gap |
| 44 | Flange bores |
| 46 | Eccentric bolt |
| 48 | Eccentricity |
| 50 | Head |
| 52 | Rotary pin of the eccentric bolt |
| 54 | Guide element |
| 56 | Slot |
| 58 | Adjustment element |
| 60 | Coupling element |
| A | Displacement direction |
| B | Direction of rotation |

1. A rotating unit for rotating a first component of a wind turbine in relation to a second component of the wind turbine, the first component being mounted in a rotatable manner on the second component, comprising:
a gearwheel element, which is arranged on the first component,
a drive, which is arranged on the second component by means of a drive holder and which has a drive housing and a drive pinion for actuating the gearwheel element,
a connecting element, which is arranged on the drive housing and is configured for forming a releasable connection between the drive housing and the drive holder, and
fastening means, which interact with the connecting element and can be actuated between a clamping position and a disengagement position,
wherein the fastening means connects the drive housing, in the clamping position, in a force-fitting manner to the drive holder, and
wherein it is possible for the drive housing, in the disengagement position, to be displaced on the drive holder in a stepless manner in an adjustment direction (A) such that, by virtue of the displacement, it is possible to adjust a tooth-flank clearance between the drive pinion and the gearwheel element, and
wherein the drive housing, in the disengagement position, can be displaced by virtue of the rotation of at least one eccentric bolt, which can be coupled to the connecting element, in relation to the gearwheel element.

2. The rotating unit as claimed in claim 1, wherein the first component is a rotor hub and the second component is a rotor blade, or the first component is a tower and the second component is a machinery carrier with a nacelle.

3. The rotating unit as claimed in claim 1, wherein the second component is a rotor hub and the first component is a rotor blade, or the second component is a tower and the first component is a machinery carrier with a nacelle.

4. The rotating unit as claimed in claim 1, wherein the drive housing can be displaced in a number of adjustment directions spanning an adjustment plane, and wherein at least some of the fastening means, in the disengagement position, limit displacement of the drive housing in a direction perpendicular to the adjustment plane.

5. The rotating unit as claimed in claim 1, wherein the eccentric bolt has an actuating element, by means of which the at least one eccentric bolt can be rotated.

6. The rotating unit as claimed in claim 1, wherein the drive housing, during displacement on the drive holder, is guided positively by at least one guide element.

7. The rotating unit as claimed in claim 6, wherein an axis of rotation of the eccentric bolt and the at least one guide element are positioned along a straight line which intersects an axis of rotation of the gearwheel element.

8. The rotating unit as claimed in claim 1, wherein the drive housing is guided such that a rotary movement of the eccentric bolt is converted, at least in certain regions, into an approximately rectilinear movement of the drive housing.

9. A method of displacing a drive of a rotating unit as claimed in claim 1, which comprises:
actuating the fastening means into the disengagement position in order to release the force-fitting connection between the drive housing and the drive holder,
rotating the eccentric bolt in order to displace the drive housing on the drive holder, and
actuating the fastening means into the clamping position in order to re-establish the force-fitting connection between the drive housing and the drive holder.

10. The method as claimed in claim 9, further comprising one or both of:
coupling the eccentric bolt to the connecting element such that rotation of the eccentric bolt gives rise to displacement of the drive housing in relation to the gearwheel element, and
uncoupling the eccentric bolt from the connecting element.

11. A wind turbine having a rotating unit as claimed in claim 1.
